(19) United States
(12) Patent Application Publication
(10) Pub. No.: US 2005/0143872 A1
(43) Pub. Date: Jun. 30, 2005

(54) Aircraft gps instrumentation system and relative method

(76) Inventor: Alessandro Barazzetti, Como (IT)

Correspondence Address: WENDEROTH, LIND & PONACK, L.L.P., 2033 K STREET N. W., SUITE 800, WASHINGTON, DC, 20006-1021, US

(21) Appl. No.: 10/501,552

(22) PCT Filed: Jan. 15, 2003
(86) PCT No.: PCT/EP03/00349

(30) Foreign Application Priority Data
Jan. 18, 2002 (IT) MI2002A000088

(51) Int. Cl. G06F 17/00

(52) U.S. Cl. 701/4; 340/945

(57) ABSTRACT

The present invention refers to an instrumentation system of an aircraft by means of GPS (Global Positioning System). In particular, it refers to a modular instrumentation system for aircraft, preferably airplanes, based on the GPS, and to the relative method. In one embodiment the modular instrumentation system for aircraft comprises: four antennas (A1-A4) connected to four GPS receivers (GPS1-GPS4) that supply in output the attitude data and the angular velocities; a data acquisition card (S, C) that receives, memorizes and processes said attitude data and said angular velocities coming from said data acquisition card (S, C) and supplies data relating to the board instruments of an aircraft; visualization means (V) of said data relating to the board instruments.

The present invention refers to a GPS (Global Positioning System) aircraft instrumentation system. More in particular, it refers to a modular instrumentation system for aircraft, preferably airplanes, based on GPS, and to the relative method.

GPS is a radiolocation and positioning system consisting of a constellation of 24 satellites in a circular orbit, 20,000 Km from the Earth. The orbital configuration for the GPS system has been chosen to provide a continuous global covering on the entire terrestrial surface, making at least 5 satellites available contemporarily visible from any part of the globe.

It is capable of providing the position (in latitude, longitude and altitude) of a receiving terminal in any part of the world it is located with an accuracy of several tens of meters.

The operating principle of the GPS is basically simple: it regards determining the distance from three satellites S1, S2, S3, whose position in space is known with precision, and then, by means of suitable mathematical passages, determining its own position.

In fact, the distance from the three satellites corresponds to the determination of three spheres having their center on the satellites themselves. The intersection of the three spheres determines two points. Of the two solutions the closest one to the terrestrial surface (and also valid for objects placed in low orbits) is considered.

The position thus obtained is a position relating to the space identified by the three satellites and referred to a system of coordinates denominated ECEF (Earth Centered, Earth Fixed).

To have a more conventional position reference, altitude above sea level and geographic coordinates, the receiver will have to carry out suitable conversions of coordinates.

The GPS offers two levels of services: the Standard Positioning Service and the Precision Positioning Service. The Standard Positioning Service (SPS) is a service of positioning and timing available in continuity to all the GPS users, usable around the world without any particular request.

The Standard Positioning Service is transmitted on the frequency L1 (1575.42 MHz) and contains a code of common communication (C/A) and navigation data. This signal is transmitted by means of a pseudo-random code (PRN) that modulates the carrier L1 with BPSK modality.

Several antennas and several GPS receivers are normally used for determining the attitude of an aircraft.

In order to be piloted the aircrafts also require a series of instruments, such as the artificial horizon, altimeter, turn and bank indicator, variometer, anemometer, gyrocompass, etc. Each of these instruments usually requires particular sensors, possibly with moving parts, and they need periodical maintenance.

In view of the state of the technique described, an object of the present invention is to provide a modular GPS aircraft instrumentation system.

In accordance with the present invention, this and other objects are achieved by means of a modular instrumentation system for aircraft comprising: four antennas connected to four GPS receivers that provide the attitude and the angular velocities in output; a data acquisition card that receives, memorizes and processes said attitude data and said angular velocities coming from said data acquisition card and supplies data relating to the board instruments of an aircraft; visualization means for said data relating to the board instruments.

These objects are also achieved by means of a method for determining the parameters relating to the aircraft instrumentation comprising the following phases: to receive a series of attitude data and the angular velocities from four GPS receivers; to calculate the average values of said attitude data and of said angular velocities; to memorize said data; to process said attitude data and said angular velocities; to supply data relating to the board instruments to an aircraft; to visualize said board instruments of an aircraft.

Thanks to the present invention a complete modular aircraft instrumentation system can be realized, which is simple to install, also on ultra light aircraft, having zero maintenance.

The elimination of the different sensors and of their interfaces leads to the reduction of costs, energy consumption, weight and the complexity of the instrumentation.

In addition the visualization of the information on a special monitor in the form of traditional instrumentation enables a navigation system to be produced, without mobile parts, easily intelligible.

The characteristics and advantages of the present invention will be apparent from the following detailed description of an embodiment thereof, illustrated as non-limiting example in the enclosed drawings, in which:

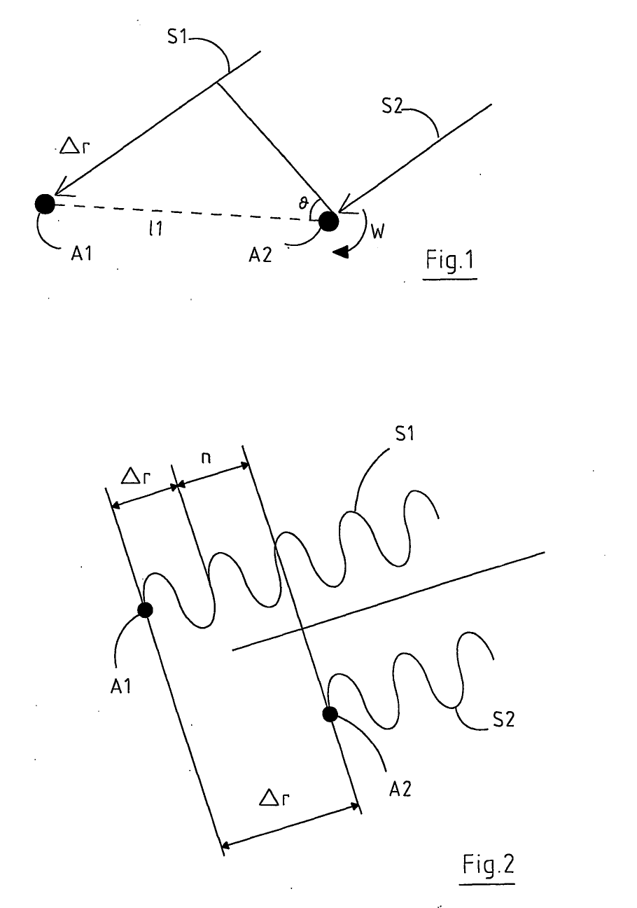

FIG. 1 and FIG. 2 represent the geometry of a set of antennas;

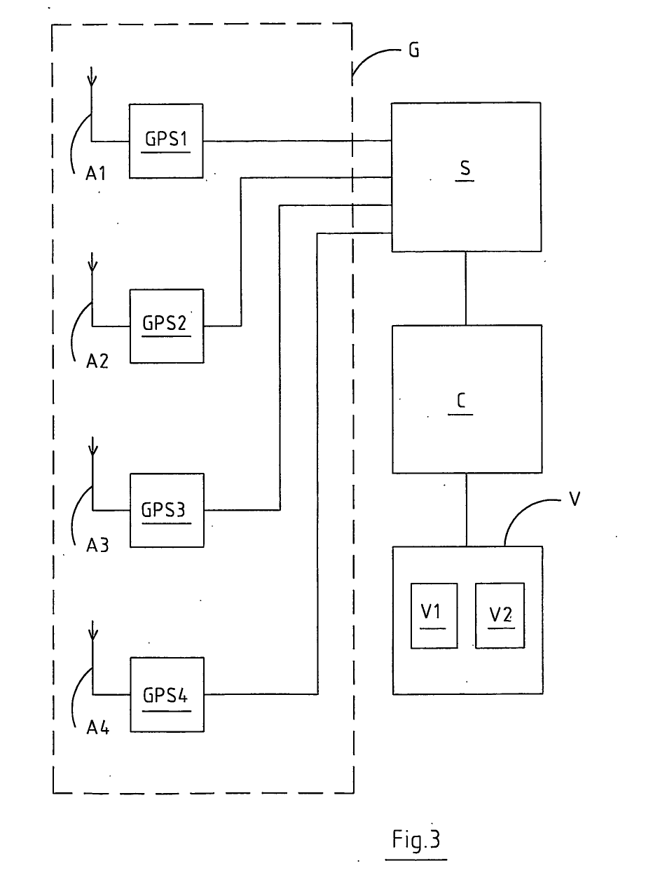

FIG. 3 represents a block diagram of the instrumentation system of an aircraft by means of GPS in accordance with the present invention;

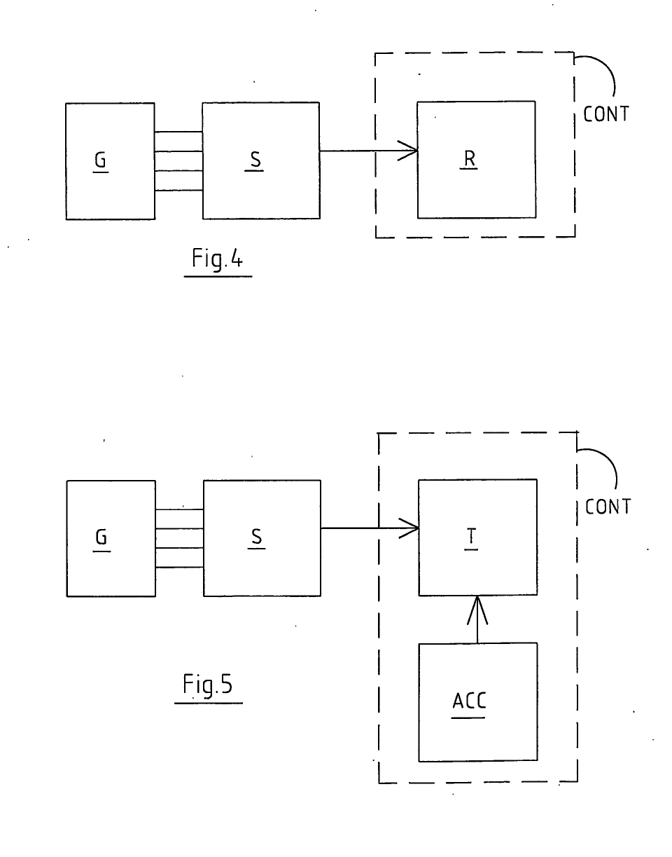

FIG. 4 represents a block diagram of a first variant of the GPS aircraft instrumentation system in accordance with the present invention;

FIG. 5 represents a block diagram of a second variant of the GPS aircraft instrumentation system in accordance with the present invention;

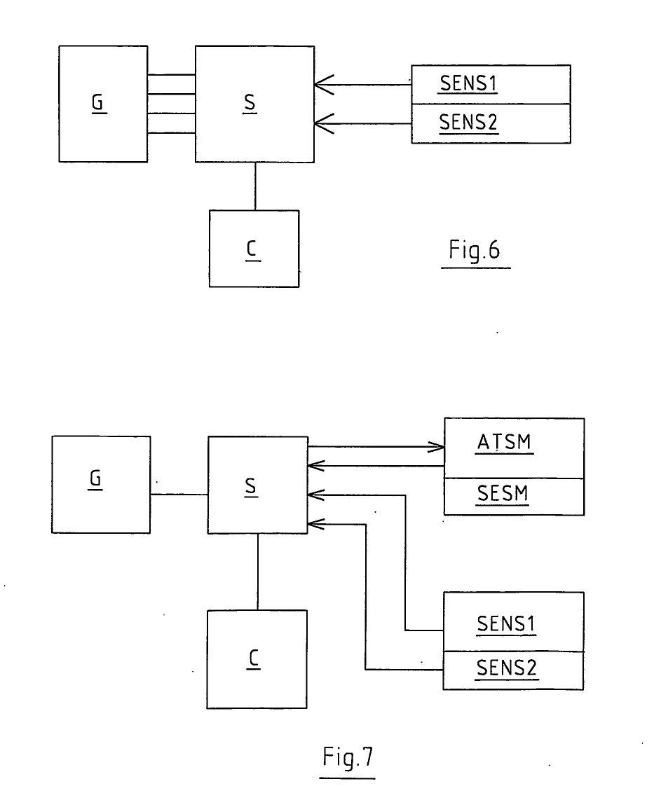

FIG. 6 represents a block diagram of a third variant of the GPS aircraft instrumentation system in accordance with the present invention;

FIG. 7 represents a block diagram of a fourth variant of the GPS aircraft instrumentation system in accordance with the present invention.

By attitude of a body it is meant the orientation of a triad of axes that identify the body itself, in relation to a second triad of axes taken as reference. The attitude of the body can be expressed, in relation to the reference system, by means of a rotation matrix called attitude matrix.

As can be seen from FIG. 1 and FIG. 2, between two antennas A1 and A2 that receive the signals S1 and S2, respectively, the relative position vector can be defined, called base line 11, and from the calculation of the difference phase measured between the two antennas, the orientation of this vector can be defined.

The difference of phase θ between the signals S1 and S2 can be determined from the difference in path covered by the signal to reach the two antennas, that is Δr.

Thus:
Δr=\overline{b}^{T}\overline{s}=|\overline{b}|·cos θ=λ(Δφ−n)
where:
Δr is the path difference covered by the signal,
b is the vector that identifies the base line,
s is the vector of the arrival direction of the signal named line of sight,
λ is the wavelength of the GPS signal,
Δφ is the fractional phase difference,
n is the whole phase difference.

The base lines are expressed in the body axes reference system, while the lines of sight of the signal, which are practically the conjunction between the receiver and the GPS satellite, are expressed in relation to the reference system of the inertial triad of the aircraft.

The transformation needed to represent the base lines and the lines of sight in the same reference system is no other than the attitude matrix A.
Δr=\overline{b}^{T}A\overline{s}=|\overline{b}|·cos θ

Thus the determination of the attitude by means of GPS consists in calculating the attitude matrix A by measuring the path difference Δr of the lines of sight.

The attitude matrix is a square matrix 3×3, but of the nine elements only three are linearly independent. In fact the elements of the matrix are connected by relations that express the squareness and the orthonormality of the axes. Thus in order to obtain the attitude matrix three equations are necessary, that is three secondary (slave) antennas are necessary, each of which generates with the principal (master) a base line, and a satellite that is constantly visible.

In this manner the matrix A is calculated simply deterministically, and thus the precision of the results cannot be greater than that of the measurements available.

To increase the precision of the determination of attitude by means of GPS, we pass, in accordance with the present invention, to a statistical approach so as to limit the errors. It is thus necessary to collect a series of measurements from which the statistical information is to be taken (that is, to calculate the average values) capable of improving the process for determining the attitude matrix.

Instead of proceeding by using the three scalar relations, used in the deterministic case, several measurements are used taken from several satellites on each base line, thus:
Δrᵢₖ=\overline{b}ₖ^{T}A\overline{s}ᵢ
where:
i is the ID of the satellite GPS i-th
k is the ID of the base line k-th.

With the same principle used to determine the path difference covered by the signal, we can also determine the angular velocities.

Considering the process for calculating the path difference covered by the signal the calculation of the angular velocities gives the following result:
Δ\dot{r}=\overline{b}^{T}[ωΛ]·A\overline{s}
where:
Δ\dot{r} is the angular rotation velocity of the couple of antennas expressed in relation to the inertial triad of the aircraft;
A is the attitude matrix;
ωΛ is a matrix that has the components of the vector ω as elements multiplied by the components of the vectors of the directions of the inertial triad of the aircraft.

Also in the case of the angular velocities, in order to increase the precision in determining the estimates, we pass, in accordance with the present invention, to a statistic approach so as to limit the errors. It is thus necessary to collect a series of measurements from which the statistical information is to be taken capable of improving the process for determining the attitude matrix.

Also in this case, instead of proceeding by using the three scalar relations, used in the deterministic case, several measurements are used taken from several satellites on each base line, thus:
Δrᵢₖ=\overline{b}ₖ^{T}[ωΛ]·A\overline{s}ᵢ
where:
i is the ID of the satellite GPS i-th
k is the ID of the base line k-th

However, the GPS receivers normally measure only the fractional part of the phase Δφ of the carrier, thus it is necessary to determine how many wavelengths of the carrier exist between the two antennas in a certain time, see FIG. 2. This is due to the fact that the wavelength of the carrier is very small (only 19.03 cm.). Thus the measurement of the phase difference Δφ must consider the number n of the whole existing cycles. It is thus necessary to determine the whole cycles n that lie on the projection of the base line on the arrival direction of the GPS signal. This uncertainty is called resolution of ambiguity of the whole.

In accordance with the present invention, this uncertainty is resolved by means of a method that avoids the inversion of large matrixes and uses a non-iterative procedure. First of all the method introduces a geometric inequality to reduce the research space, then a group loss function is used to select the solution and thus a final control of the solution is made by means of an integrity control of the errors on the covariant matrix.

Assuming that all the base lines are coplanar a series of lines of sight not in the same plane must be available. For three lines of sight, the research space consists of k³ possible permutations of wholes.

Applying an inequality to the iₜₕ base line, the number of combinations falls around 3k². The reduced number of wholes consists of those that meet the following inequality.
∥bᵢ∥²>∥bᵢ∥²(s₁s₂)²+(Δ [symbol] ᵢ₁−nᵢ₁)²−2(Δ [symbol] ᵢ₁−nᵢ₁)²(Δ [symbol] ᵢ₂−nᵢ₂)²(s₁s₂)+(Δ [symbol] ᵢ₂−nᵢ₂)²

This equation reduces the research space since for each base line only two lines of sight are considered simultaneously instead of three.

The group loss function to select the solution is the following that has to be minimized.

$$J ( {n}_{i} ) = \frac{1}{2} {\sum }_{k = 1}^{L} \{ {\frac{1}{{σ}^{2}} [ {‖ {S}_{i}^{- 1} ( k ) {Γ}_{i} ( k ) ( {Φ}_{i} ( k ) - {n}_{i} ) ‖}^{2} - \\ {‖ b ‖}^{2} + trace \{ {S}_{i}^{- 1} ( k ) \} ]}^{2} + log {σ}_{i}^{2} ( k ) \}$$

where

$${σ}_{i}^{2} = - {trace}^{2} \{ {S}_{i}^{- 1} ( k ) \} {( {Φ}_{l} ( k ) - {n}_{i} )}^{T} {Γ}_{i}^{T} ( k ) {S}_{i}^{3} ( k ) {Γ}_{i} ( k ) ( {Φ}_{i} ( k ) - {n}_{i} )$$

$${Γ}_{i} = \vert {ω}_{i1}^{- 2} {s}_{1} {ω}_{i1}^{- 2} {s}_{2} {ω}_{i1}^{- 2} {s}_{3} \vert$$

$${Φ}_{i} = [ \begin{matrix}Δ {Φ}_{i1} \\ Δ {Φ}_{i2} \\ Δ {Φ}_{i3}\end{matrix} ] {n}_{i} = [ \begin{matrix}{n}_{i1} \\ {n}_{i2} \\ {n}_{i3}\end{matrix} ]$$

$${S}_{i} = {ω}_{i1}^{2} {s}_{1} {s}_{1}^{T} + {ω}_{i2}^{2} {s}_{2} {s}_{2}^{T} + {ω}_{i3}^{2} {s}_{3} {s}_{3}^{T}$$

To ensure that the solution is optimal the estimation of the error of the covariance is used.

$${P}_{i} = \{ {\sum }_{k = i}^{L} \frac{4}{{σ}_{i}^{2} ( k )} {\vert {Φ}_{i} ( k ) - {n}_{i} {Φ}_{i} ( k ) - {n}_{i} \vert}^{T} \}$$

The group of wholes selected is controlled by means of an inequality on the diagonal elements of the matrix of the covariance.

The reflections of the signals, received by the GPS receivers, due to the multiple paths (multipath) also contribute to the indetermination of the result. To remove these errors, in accordance with the present invention the Kalman filter is used extended to non-linear systems.

With the Kalman filter the interest quantity is estimated, so that at the end of the calculation process the residual error is minimum; to this purpose an estimation to the square minimum can be used.

The Kalman filter is an excellent observer, applied to a dynamic system submitted to casual perturbations. More precisely, the Kalman filter is a linear method with minimum error variance, capable of estimating excellently the unknown state of a dynamic system, by means of measurements, innate with noise, sampled at discrete timing.

This method is efficient and extremely simple. The negative aspect is the use of large dimensioned matrixes.

Considering that the Kalman filter has the structure of an observer, it is only necessary to find the matrix excellent gain K. In fact the estimation of the state conveyor derives, both from knowing the estimation of the previous step, and from the current measure. The observer has to suitably weigh these two items of information, that is, it has to determine the suitable matrix of gain. The importance to give to the previous estimation or to the current measure must take in consideration the imprecision accumulated during the entire process up to the moment considered and the influence of the noise on the measurements collected.

But the Kalman filter is very versatile and it is thus possible to apply it also in the systems governed by non-linear equations. In the case of the non-linear model, only a linearization of the equations is necessary, through the Taylor approximation. At this point it is possible to extend the concepts of the case of a linear system, to a non-linear system. In this case the filter is called extended Kalman filter.

The attitude of the aircraft and the angular velocities thus determined, the parameters of the board instruments are determined.

We now refer to FIG. 3 that represents a block diagram of the GPS aircraft instrumentation system in accordance with the present invention.

Four antennas A1-A4 are connected to four receivers GPS1-GPS4, in turn connected to a data acquisition card S. The data acquisition card S is preferably connected to a computer C in turn connected to a visualization system V composed preferably of two visualizers V1 and V2. In a preferred embodiment the visualizer V1 is set up for the visualization of the board instruments and the visualizer V2 is set up for the visualization of a map with the position of the aircraft. In alternative, the data acquisition card S can directly pilot the visualization system V. The antennas A1-A4 and the receivers GPS1-GPS4 are grouped to form a GPS receiving system called G.

The minimum distance between the antennas is 1 m and they can be either coplanar or on different planes.

Each GPS receiver generates two blocks of data. The first (NAVDATA) contains the information regarding latitude, longitude, altitude and speed on the three axes and represents the information already processed by the receiver. The second record contains the raw data (RAW DATA) regarding the satellites sighted by the receiver at that moment (commercial receivers are capable of managing up to a maximum of 12 signals simultaneously coming from 12 satellites) and contain the phase information of the signal which is essential for calculating the attitude.

The two records are in ASCII format, in accordance with the protocol NMEA0183. The input (commands) and the output (data) of the GPS receivers must be controllable through their serial outputs. A GPS receiver suitable for the present invention is for example the commercial product called Garmin.

The antennas A1-A4 receive the signals from the GPS satellite constellation.

The data acquisition card S sends a data acquisition command to the four receivers GPS1-GPS4, they acquire the RAW DATA (max 12 for each receiver) and the NAVDATA and send it to the data acquisition card S, which processes it in accordance with the above described method and generates the 3 attitude angles and the 3 angular velocities.

The data acquisition card S sends the 3 attitude angles and the 3 angular velocities to the computer C that generates the parameters of the board instruments (artificial horizon, altimeter, turn and bank indicator, roll and pitch, variometer, anemometer, directional gyrocompass, G-Metro) and the graphics of these that are sent to the visualizer V1.

The altimeter is an instrument used to measure the vertical distance of an object (aircraft) in relation to a fixed level (for example the average level of the sea MSL: Mean Sea Level).

On modern airplanes two types of altimeter are installed: the pressure altimeter and the radar altimeter.

The pressure altimeter measures the variation of the static pressure outside the airplane and transforms it into an indication of altitude in relation to a reference pressure that can be selected on the same altimeters with a special knob. The altitude indication is normally presented by means of an index (to indicate the hundreds and thousands of feet). The fault of this system consists in imposing the reference value for the pressure.

The radar altimeter is instead an instrument that measures, by means of radio waves, the vertical distance of an object (aircraft) in relation to the ground below. The radar altimeters on board commercial airplanes are used only for altitudes from 0 to 2500 feet and guarantee excellent precision.

The altimeter generated through GPS offers the same precision as that of a radar altimeter but without the limitation on the altitude used.

The altitude value in relation to the reference geoid WGS84 is extracted directly from the NAVDATA.

The attitude indicator, also called “artificial horizon”, is the only instrument that permits the simultaneous control of the pitch/attitude of the airplane and the degree of turn/roll. It is normally controlled by a two-degrees-of-freedom gyroscope that maintains its orientation in relation to the real horizon even when the airplane is inclined, rises or descends. The attitude indicator can replace the vision of the real horizon in the absence of external visibility.

By the use of the angles and of the angular velocities processed by the RWADATA we can construct the artificial horizon without needing gyros.

We construct the attitude matrix A as explained previously.

With the elements of the matrix A we construct graphically the attitude of the aircraft.

The speed at which an airplane moves through the surrounding air can be measured and calculated in various manners. The IAS (Indicated Air Speed) is the speed indicated by the anemometer and is expressed in knots.

The anemometer or speed indicator relating to the air is an instrument that enables us to measure and indicate the speed of the airplane in relation to the external air that surrounds it.

The instrument, called pitot tube, measures the difference between impact and static pressure thus obtaining dynamic pressure that can be converted in speed values, normally indicated in knots by index or counters.

The CAS (Calibrated Air Speed) is obtained from the speed indicated correcting both the instrumental error and the position error. The TAS (True Air Speed) is obtained again from the speed indicated by applying the corrections of air density on the basis of the temperature and pressure. The ground speed (GS) is obtained from the TAS introducing the correction for opposing wind or tail wind.

The conveyor speed whose module corresponds to the GS is extracted directly from the NAVDATA

It is a measurement of speed that prescinds from the barometric measurements and from the relative corrections of the atmospheric values.

The turn and bank indicator is an instrument capable of indicating simultaneously the turn angle of an aircraft and if it is being made in a coordinated manner or not. Generally the turn and bank indicator consists of two instruments: a gyroscope to indicate by means of index if the aircraft is turning right or left, and a curvilinear ball level to indicate if the turn is being made in a coordinated manner and therefore without banking. Only when the ball is centered is the aircraft carrying out a coordinated turn, as in this case the force of gravity combined with the centrifugal force of the turn maintains the ball at the center.

The attitude matrix, the angular velocities and the components of the speed on three axes are extracted from the RAWDATA calculations.

With this information the bank-and-turn indicator can be reconstructed without having gyroscopes or levels.

The variometer is an instrument that measures the vertical component of the speed by means of an acceleration sensor (damper).

With this instrument the pilot can know if the aircraft gains or losses altitude regardless of the attitude of the aircraft.

The Vz, that is the speed component along the axis perpendicular to the direction of the wind relative speed, is obtained directly from the RAWDATA.

When the position in terms of latitude, longitude and altitude is known, the position of the cardinal points is known and thus we can visualize the compass needle.

When the speed vector is known in its three axes of the inertial triad we can visualize the movement of the compass needle according to the direction of the aircraft heading.

The variations of speed in time along the three axes give us the accelerations that are composed in the acceleration vector of the aircraft a.

If we project the vector a in the direction of gravity acceleration g we have the acceleration component, that can be expressed as a number multiple of g.

The computer C also processes NAVDATA, which over imposed on a suitable memorized digital map enable us to obtain the moving map on the visualizer V2.

Using the above-described system as principal unit and replacing or adding other units, described below, it can be used with various purposes. The subsystems can then be added to each other to form an integrated air navigation structure, which with one single technological principle, the GPS, can provide a versatile and safe aircraft (IFR).

We now refer to FIG. 4 that represents a block diagram of a first variant of the instrumentation system of an aircraft by means of GPS in accordance with the present invention.

The GPS receiving system called G is connected to the data acquisition card S and thus to a recorder R enclosed in a container CONT. The recorder R is for example constituted by a magnetic tape recorder for aeronautic use and the container CONT is a steel-clad container.

The data acquisition card S transmits the attitude data (3 angles and 3 angular velocities), the position (latitude, longitude and altitude) and the date and the time, at regular intervals, to the recorder R to be recorded. Thus we have a real black box that, in the event of investigation, enables the mechanics, causes and responsibility of accidents to be determined.

We now refer to FIG. 5 that represents a block diagram of a second variant of the instrumentation system of an aircraft by means of GPS in accordance with the present invention.

The GPS receiving system called G is connected to the data acquisition card S and thus to a mobile telephone T, to which an acceleration sensor ACC is connected, enclosed in a steel-clad container CONT.

The data acquisition card S transmits the position data (latitude, longitude an altitude) to the mobile telephone T that preferably also comprises a memory (not shown) suited to memorizing the data received from the data acquisition card S. The acceleration sensor ACC in the event of an accident, and thus in the event that the acceleration exceeds a preset limit, activates the mobile telephone T transmitting the position data memorized. In this case we achieve a safety system capable of immediately signaling the exact position to enable rapid locating and rescue.

We now refer to FIG. 6 that represents a block diagram of a third variant of the instrumentation system of an aircraft by means of GPS in accordance with the present invention.

The GPS receiving system denominated G is connected to the data acquisition card S in turn connected to the computer C and to a pair of sensors SENS1 and SENS2. The sensor SENS1 is a position sensor of the motor throttle, that is it indicates a value proportional to the accelerator of the aircraft. The sensor SENS2 is a fuel level indicator sensor. The measurement of the fuel level and knowing the position of the motor throttle, together with knowing the consumption data of the aircraft motor, enable the position of the aircraft to be predicted. The pilot enters the data relating to the motor, the destination and the intermediated points into the computer C. The computer generates in real time the evolution of the route and suggests the attitude and position of the throttle to the pilot so as to reach the destination entered in the shortest time or the lowest consumption in great details. It can also reprogram the route for the intermediate points in case of emergency. Through the continuous and automatic reconfiguration of the system the pilot always knows where he/she is and what he/she has to do to safely reach preset points even with reduced visibility. The visualization system V can in addition show the motor instruments such as set power and fuel level.

We now refer to FIG. 7 that represents a block diagram of a fourth variant of the instrumentation system of an aircraft by means of GPS in accordance with the present invention.

The GPS receiving system called G is connected to the data acquisition card S in turn connected to the computer C and to the pair of sensors SENS1 and SENS2. As in FIG. 6, the sensor SENS1 is a position sensor of the motor throttle, that is, it indicates a value proportional to the position of the accelerator of the aircraft. The sensor SENS2 is a fuel level indicator sensor. The data acquisition card S receives in input the signal coming from the position sensors of the mobile surfaces SENM (one per mobile surface), and provides in output the signals for the actuators of the mobile surfaces ATSM (one per mobile surface). The system carries out the same functions as in the example in FIG. 6 but, thanks to the presence of the control of the aircraft's mobile surfaces, it automatically carries out all the route and attitude adjustments so that the destination can be reached in complete autonomy. Thus we have a real autopilot that can be adapted to any aircraft to permit long distance transfers with minor fatigue for the pilot.

The variants of the instrumentation system of an aircraft by means of GPS herein described can be used as they are or can be partially or completely integrated with each other.

1. Modular instrumentation system for aircraft comprising: four antennas (A1-A4) connected to four GPS receivers (GPS1-GPS4) that provide in output the attitude data and the angular velocities; a data acquisition card (S, C) that receives, memorizes and processes said attitude data and said angular velocities coming from said data acquisition card (S, C) and provides data relating to the board instruments of an aircraft; visualization means (V) of said data relating to the board instruments.

2. Modular instrumentation system for aircraft in accordance with claim 1 characterized in that data acquisition card (S, C) carries out a series of measurements from which the statistic information is taken, that is it calculates the average values of said attitude data and of said angular velocities.

3. Modular instrumentation system for aircraft in accordance with claim 1 characterized in that said board instruments comprise at least one of the following instruments: artificial horizon, altimeter, turn and bank indicator, roll and pitch, variometer, anemometer, directional gyrocompass, G-Metro.

4. Modular instrumentation system for aircraft in accordance with claim 1 characterized in that it comprises a computer (C) that processes the said attitude data and said angular velocities coming from said data acquisition card (S) and supplies data relating to the board instruments of an aircraft.

5. Modular instrumentation system for aircraft in accordance with claim 1 characterized in that it comprises a recorder (R) suited to recording the attitude data, the position of an aircraft and the date and the recording time, at regular intervals.

6. Modular instrumentation system for aircraft in accordance with claim 1 characterized in that it comprises a mobile telephone (T), a memory suited to memorizing the data received from the data acquisition card and an acceleration sensor (ACC) suited to activating said mobile telephone (T) and transmitting said data.

7. Modular instrumentation system for aircraft in accordance with claim 1 characterized in that it comprises a position sensor of the motor throttle (SENS1) and a fuel level indicator sensor (SENS2).

8. Modular instrumentation system for aircraft in accordance with claim 7 characterized in that it comprises position sensors of the mobile surfaces (SESM) and actuators of the mobile surfaces (ATSM).

9. Modular instrumentation system for aircraft in accordance with claim 1 characterized in that said data acquisition card (S) processes said attitude data and said angular velocities, integrates them with the data relating to a digital map and transmits them to a said visualization means (V).

10. Method for determining the parameters relating to the instrumentation for aircraft comprising the following phases: receiving a series of attitude data and the angular velocities from four GPS receivers (GPS1-GPS4); calculating the average values of said attitude data and of said angular velocities; memorizing said data; processing said attitude data and said angular velocities; supplying data relating to the board instruments of an aircraft; visualizing said board instruments of an aircraft.

11. Method in accordance with claim 10 characterized in that it introduces a geometric inequality to reduce the research space of the measurement of the phase difference, utilizes a group loss function to select the solution; controls the solution by means of an integrity control on the covariant matrix of the errors.

12. Method in accordance with claim 10 characterized in that it uses an extended Kalman filter for the non-linear systems to eliminate the errors caused by multipaths.
